(19) United States
(12) Patent Application Publication
(10) Pub. No.: US 2014/0070608 A1
(43) Pub. Date: Mar. 13, 2014

(54) MOTOR VEHICLE WITH A MULTI-VOLTAGE ONBOARD ELECTRICAL SYSTEM AND ASSOCIATED METHOD

(71) Applicant: Audi AG, Ingolstadt (DE)

(72) Inventors: Siegfried Achhammer, Regensburg (DE); Josef Winkler, Kipfenberg (DE)

(73) Assignee: Audi AG, Ingolstadt (DE)

(21) Appl. No.: 13/973,683

(22) Filed: Aug. 22, 2013

(30) Foreign Application Priority Data
Sep. 7, 2012 (DE) 10 2012 017 674.0

(51) Int. Cl. B60R 16/033

(52) U.S. Cl. CPC B60R 16/033
USPC 307/10.1

(57) ABSTRACT

A motor vehicle with an electrical system includes a low-voltage network with a first electrical energy storage device operating at a first voltage and a high-voltage network with second electrical energy storage device operating at a second voltage higher than the first voltage. The second energy storage device is divided in a first partial energy storage device that has the same voltage as the first energy storage device and is connected in parallel with the first energy storage device, and a second partial energy storage device that is connected in series with the first partial energy storage device.

### CROSS-REFERENCES TO RELATED APPLICATIONS

This application claims the priority of German Patent Application, Serial No. 10 2012 017 674.0, filed Sep. 7, 2012, pursuant to 35 U.S.C. 119(a)-(d), the content of which is incorporated herein by reference in its entirety as if fully set forth herein.

### BACKGROUND OF THE INVENTION

The present invention relates to a motor vehicle with an onboard electrical system which has a low-voltage network with a first electrical energy storage device with a first voltage and a high-voltage network with a second electrical energy storage device with a second voltage which is higher than the first voltage. In addition, the invention relates to a method of operating a load realizing a comfort function in such a motor vehicle.

The following discussion of related art is provided to assist the reader in understanding the advantages of the invention, and is not to be construed as an admission that this related art is prior art to this invention.

More and more frequently, loads in motor vehicles are proposed that require a higher voltage than the voltage typically used in onboard electrical systems, for example 12V. Examples of such loads are a front windshield heater intended to clear a front windshield of the motor vehicle from snow and ice as fast as possible, as well as electric turbochargers and the like. For this reason, it has been proposed to expand the electrical system of the motor vehicle with a high-voltage network for such loads, for example a 48 V network. Different variants are known in the prior art for realizing such multi-voltage onboard electrical systems, meaning onboard electrical systems having sub-networks with different voltages.

In a first solution, the so-called island solution, it has been proposed to generate the voltage for the load requiring the higher voltage from the low-voltage network, for example the 12 V network, by using a DC converter (DC/DC converter). However, this is disadvantageous because of this places a high load on a generator of the vehicle and a first energy storage device in the low-voltage network, respectively.

It has also been proposed to connect a first energy storage device and a second energy storage device, which are each associated with a corresponding low-voltage onboard electrical system and a corresponding high-voltage onboard electrical system, in series so that the required second voltage in a high-voltage onboard electrical system branch is obtained by combining the two energy storage devices. The variant described therein has the advantage that the added second battery can also be used for 12 V loads in the low-voltage onboard electrical system.

However, disadvantageously, the first energy storage device is typically implemented as a lead-acid battery and is also used in the higher voltage, so that a high-voltage load produces a significant feedback on the low-voltage onboard electrical system. For example, a hysteresis exists of 1 V or more exists in lead-acid batteries between the charging and discharging voltage, causing the discharge to begin only from, for example, 12.5V on. Assuming now a current pulse of 150 A on the high-voltage side and an internal battery resistance of the first battery storage device of 10 mO, then the voltage drops from 12.5 V to 11.0 V, causing voltage fluctuations that can limit or jeopardize the function of loads of the low-voltage network, which is especially important for safety-related loads, but which may cause flicker and the like in, for example, comfort loads. Another disadvantage of prior art arrangements is that the 12-V battery, i.e. the first energy storage device, is also additionally cycled via the high-voltage load, which limits the service life.

It would therefore be desirable and advantageous to obviate prior art shortcomings and to provide an improved onboard electrical system for a motor vehicle, which avoids as much as possible voltage drops on the low-voltage side during the operation of high-voltage loads and thus increases the service life of a first energy storage device of the low-voltage network.

### SUMMARY OF THE INVENTION

According to one aspect of the present invention, a motor vehicle includes an onboard electrical system, wherein the onboard electrical system has a low-voltage network operating at a first voltage and having a first electrical energy storage device, and a high-voltage network operating at a second voltage higher than the first voltage and having a second electrical energy storage device. The second energy storage device is divided in a first partial energy storage device that has a voltage corresponding to the voltage of the first energy storage device and is connected in parallel with the first energy storage device, and a second partial energy storage device that is connected in series with the first partial energy storage device.

According to the invention, it is therefore proposed to divide the second energy storage device so as to produce a configuration of energy storage devices in which two energy storage devices are connected in parallel in the low-voltage network, namely the first energy storage device, typically a lead-acid battery, and the first partial energy storage device. Connected in series therewith towards the high-voltage network is an additional energy storage device, namely the second partial storage device. In other words, this can be viewed as providing a center tap the second energy storage device. This configuration has a number of advantages. For example, when another energy storage device, which has preferably no hysteresis between the charging voltage and discharging voltage, is connected in parallel with the first energy storage device implemented as a 12 V lead battery, the feedback from the high-voltage side to the low-voltage side is significantly lower, because the internal resistance of the total energy storage device formed of the first energy storage device and the first partial energy storage is reduced significantly due to the parallel circuit. For example, when an energy storage device without hysteresis in the charging and discharging voltage is used as the first partial energy storage device, which is also advantageous for the second partial energy storage device, which like the first energy storage device has an internal resistance of 10 mO, the resulting total resistance is 5 mO. When a pulse of 150 A occurs in the high-voltage system, only a very small voltage drop on 13.25 V results on the low-voltage side at a charging voltage of 14 V. This clearly advantageous compared to the cited prior art.

This is in general particularly important for safety-related loads because the full functionality can be lost at a low supply voltage. However, a constant supply voltage is also relevant for comfort loads, because for example lighting devices can flicker when the voltage fluctuates.

However, the inventive embodiment has additional benefits. When, in a typical situation, a generator connected to the low-voltage network is provided in the motor vehicle, both the first energy storage device and the first partial energy storage device of the second energy storage device are charged fast by the generator. The charging time to charge the second partial energy storage device is longer with a potentially added DC-DC converter. Both the first energy storage device and the first partial energy storage device can advantageously be used for operating a starter of the motor vehicle, in particular for an internal combustion engine, thus providing more energy. However, in general, the second partial energy storage can also be used in the low-voltage network and support the low-voltage network, for example during periods of high network load and generator load. The second partial energy storage device thus operates like an additional 12 V battery.

It should be noted here that in the end, depending on the desired values for the first voltage and the second voltage, which can range, for example, from 36 to 52 V, preferably 48 volts can be used. Accordingly, the second energy storage device need not be symmetrically split, but when for example the first energy storage device is configured from individual cells, six of the cells may be connected in the low-voltage network parallel to the first energy storage device and twelve cells in series thereto for the high-voltage network.

According to an advantageous feature of the present invention, the first and/or the second partial energy storage device may be an energy storage device without hysteresis in the charging and discharging voltage. In other words, the second energy storage device is advantageously constructed from partial energy storage devices having a charging voltage substantially equal to the discharging voltage, in particular within a tolerance range, preferably ±0.1 V or less. This contributes significantly to a reduction of the voltage fluctuations in the low-voltage network, as already discussed above with reference to the exemplary calculation.

According to an advantageous feature of the present invention, the first and/or the second partial energy storage device may be a supercapacitor. Such supercapacitors are frequently also referred to as a “Supercap”. Supercapacitors are particularly suitable for applications where high power is required during a relatively short time. In particular, the present invention therefore allows dividing a supercapacitor as the second energy storage device such that a portion of the supercapacitor, i.e. the first partial energy storage device, forms an addition to a 12 V battery or to another first energy storage device.

Although the embodiment with supercapacitors is preferred in the present invention, other embodiments of the second energy storage device and its partial energy storage devices are of course also conceivable. For example, a combination of three lithium cells (LMO) and a lithium titanate cell (LTO), a combination of three lithium cells (LMO) and two nickel metal hydride cells (NiMH), or a combination of four lithium iron phosphate cells (LPO) can be used as other partial energy storage devices without hysteresis. As can be seen, different possibilities are feasible.

According to another advantageous feature of the present invention, a lithium-ion battery with the voltage corresponding to the second partial energy storage device may be connected in parallel with the second partial energy storage device. In addition to a parallel circuit in the low-voltage network, a parallel connection of energy storage devices, in this case an additional lithium-ion battery may be provided, wherein the second partial energy storage device is in this case preferably a supercapacitor. In an actual embodiment, a lithium-ion battery connected in parallel with a supercapacitor may be provided as the second partial energy storage device towards the high-voltage network, so loads that not only require high currents for short time may be allowed in the high-voltage network, i.e. high-power loads, but also high-power loads requiring energy over a longer time, which is advantageous for example with respect to a front windshield heating and the load of the high-voltage network, which would be classified as high-power load. A lithium-ion battery has here the additional advantage that it can be cycled, meaning that its service life extends over considerably more cycles than for example a lead acid battery, for example ten or even to twenty times as many cycles, so that such additionally provided lithium-ion battery need under ideal circumstances not be replaced during the life of the vehicle. The lithium-ion battery (like the second partial energy storage device) can therefore be supplied charged, so that it can be employed in particular even before a generator of the motor vehicle is operated, meaning before an internal combustion engine or the like is active, in order to activate a load, for example, a heating device, in particular a windshield heater, so that such preliminary functions can be used already before an engine start, which will be discussed in more detail below. Providing two parallel-connected energy storage devices towards the high-voltage network further reduces the load on a generator immediately after an engine start of the vehicle; in addition, the energy storage devices of the low-voltage network are relieved, which only need to provide, for example, one third of the energy of the high-voltage network.

As mentioned above, different loads may be connected to the high-voltage network. For example, a load connected to the high-voltage network may be a load providing a comfort function, or an electric turbocharger. Electric turbochargers have recently become increasingly important as an option; also, comfort functions requiring a higher voltage have become increasingly common. In particular, a load realizing a comfort function may be a heating device, particularly a heating device for a front windshield of the vehicle (front windshield heating).

The present invention can be particularly advantageously applied in this context. For example, according to another advantageous feature of the present invention, a control device may be provided which is configured to activate the load realizing a comfort function before startup of the motor vehicle, in particular before the driver enters the motor vehicle, in the presence of an activation signal. In other words, in particular before a supply of the low-voltage network is active, specifically for example before starting the engine and thus a generator, a function with a temporarily active high-voltage load is performed, because the energy for this function or for a significant part thereof is drained from the previously charged second energy storage device, so that in particular the starting capacity is not impeded by draining too much energy from a starter battery, in particular the first energy storage device. A control logic may thus be provided, which is able to activate high-power loads and/or high-energy loads, in particular a front windshield heater, in response to an activation signal already before the motor vehicle starts to operate or the engine is started.

According to another advantageous feature of the present invention, the activation signal may be transmitted, for example, by a key associated with the motor vehicle and/or a remote control associated with the motor vehicle and/or by taking into account measurement data describing the location of the key. In the first case, the user is able to activate functions, in particular heating functions, already before entering the vehicle, either by way of the key or by another remote control, so as to ideally find the motor vehicle already in a comfortable state ready for driving. For example, a windshield can already be defrosted when the driver enters the vehicle. Another variant may be the automatic activation of the vehicle functions, for example depending on the measured location of a key provided with a transponder. For example, when the control device determines that the key, and thus a user, approaches the motor vehicle and at the same time determines with a suitable sensor that heating is required, such as heating of the windshield, a fully automatic activation may also be provided.

In the illustrated embodiment of the present invention, the load on the first energy storage device, which may operate for example as a starter battery, is significantly reduced, for example down to one third, thereby retaining the engine starting capability in the low-voltage network.

It should be noted at this point, however, that the basic control method can advantageously also be used for other onboard electrical systems outside the network described above in relation to the motor vehicle according to the invention, in order to realize such functions, which allow operation of loads, in particular heating devices, before startup of the motor vehicle. Generally speaking, a motor vehicle may therefore also be provided that has a load realizing a comfort function and an electrical energy storage device associated with this load and a control device controlling the operation of this load, which is characterized in that the control device is configured to activate the load before startup of the motor vehicle, in particular before the driver enters the motor vehicle, in response to an activation signal. The activation signal may be selected as previously described. For example, embodiments are conceivable where the electrical energy storage device associated with the load is connected separately between a low-voltage network and ground, allowing this energy storage device to only supply such temporary loads. In such an embodiment, the total energy would be drawn from the energy storage device associated with the load, such that no load would be applied to a low-voltage network or a starter battery in the low-voltage network. The low-voltage network is thus further shielded from power consumption peaks and the generator can thus be designed for lower requirements.

It should be noted here that the discharging current capacity of the energy storage associated with the load may be diminished at low temperatures due to a higher internal resistance. The energy storage associated with the load should then be appropriately designed so that the initially lower current can be increased quickly by relatively fast self-heating of the energy storage device, especially of the cells of the energy storage device, with concomitant reduction of the internal resistance, so that overall a sufficient system performance is achieved. In other words, this means that for an energy storage device constructed of various cells and associated with the load, the number of cells with an internal resistance in cold conditions is selected so as to be adapted to the output resistance such that the cold current is not higher than allowed.

According to another advantageous feature of the present invention, the control device may be configured to charge the second partial energy storage device and optionally the lithium-ion battery when the load of the onboard electrical system of the motor vehicle is less than a threshold value. The second partial energy storage device (and optionally the lithium-ion battery) may then be recharged at a time when the load of the electrical system, in particular the load of a generator, is not too high. This results in a longer recharging time, which may occur in general, for example, shortly after starting the engine, especially when the energy storage devices associated the high-voltage network to be charged are already warm.

As already indicated, the high-voltage network and the low-voltage network may advantageous be interconnected via a DC-DC converter. Energy can then be exchanged between the networks. In a preferred embodiment, the motor vehicle may have a generator configured to charge the first and the second energy storage device. In addition to the first energy storage device and the first partial energy storage device, the second partial energy storage device as well as optionally the lithium-ion battery may also be charged via the DC-DC converter. As stated above, the first partial energy storage device can be charged very fast; at the same time, the DC-DC converter may be controlled accordingly, for example, to adjust the charging current for the second partial energy storage device so as to limit the load on the low-voltage network or the load on the generator. In particular, the recharging power can be set to, for example, 200 W, which is significantly lower than the required heating power of, for example, 1000 W, when for example a heating device as a load is connected to the high-voltage network.

However, energy from the second energy storage device (and possibly from the lithium-ion battery) may be used in the low-voltage network via the DC-DC converter. Likewise, at the time when for example high-voltage loads do not require energy, energy may be supplied from the high-voltage network to the low-voltage network or to its loads via the DC-DC converter.

It should be noted, however, that in principle the reverse situation is also possible, wherein a switching device for connecting a load in the high-voltage network with the first energy storage device or the first partial energy storage device of the low-voltage network when the second partial energy storage is discharged (and possibly the lithium-ion battery is discharged). Therefore, when the second partial energy storage device (and possibly the lithium ion battery) is not charged when the function is requested, the load may alternatively be at least temporarily connected to the low-voltage network and still be operated, possibly with reduced power.

According to another aspect of the invention, a method of operating in a motor vehicle a load realizing a comfort function is disclosed, wherein the motor vehicle has an onboard electrical system comprising a low-voltage network operating at a first voltage and having a first electrical energy storage device, and a high-voltage network operating at a second voltage higher than the first voltage and having a second electrical energy storage device. The method includes connecting the load to the high-voltage network, and activating the load before startup of the motor vehicle. in particular before the driver enters the motor vehicle.

As mentioned above, the method according to the invention is directed to the above-mentioned strategy for early control which can be particularly advantageously implemented with the onboard electrical system of the motor vehicle according to the invention and which provides a significant improvement in the comfort for the user of the motor vehicle. All relevant embodiments can be applied analogously to the method of the invention so that, for example, a control signal transmitted from a key and/or a remote control may be used to determine the time of activation, or the control signal may be determined by analyzing actual measurement data. Also, a charging strategy can be integrated in the method which operates generally independent of the motor vehicle according to the invention, by for an example charging energy storage devices associated with the high-voltage network, specifically the second partial energy storage device, when the load on the electrical system or the generator is low.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic diagram of a first embodiment of an onboard electrical system of a motor vehicle according to the present invention;

FIG. 2 shows a schematic diagram of a second embodiment of the onboard electrical system of the motor vehicle according to the present invention, and

FIG. 3 shows a diagram for controlling a front windshield heater.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

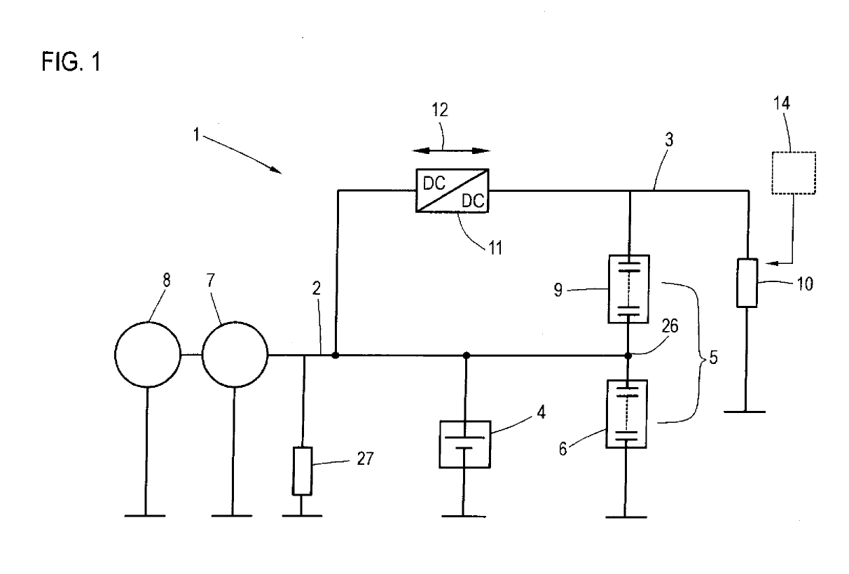

Turning now to the drawing, and in particular to FIG. 1, there is shown a schematic diagram a first embodiment of an electrical system of a motor vehicle 1 according to the invention. As seen, this is a multi-voltage onboard electrical system 1 which includes a low-voltage network 2, here operating at 12V, and a high-voltage network, 3, here operating at 48 V. Electrical energy can be supplied to the low-voltage network 2 mainly from a first energy storage device 4, in this case a conventional lead battery, and a generator 7. To provide the voltage of 48 V, i.e. the second voltage for the high-voltage network, 3, a second energy storage device 5 is provided which is here illustrated as being split.

The first partial energy storage device 6, here designed as a supercapacitor, supplies a voltage component of 12 V and is ultimately connected via the center tap 26 with the low-voltage network 2, so that it can serve, on one hand, as an additional 12 V-power source for the low-voltage network 2 and can, on the other hand, also be charged directly from the generator 7. The electrical energy stored in the first energy storage device 4 and the first partial energy storage device 6 can be used to supply power to, for example, a starter 8 connected to the low-voltage network 2 or to additional low-voltage loads 27.

It should moreover be noted at this point that the first partial energy storage device 6 may also be used like a back-up battery when the first partial energy storage device and several of the low-voltage loads 27 are disconnected by a suitable switch from the rest of the low-voltage network 2, in particular the first energy storage device 4 and the starter 8, for example, during a startup process, so as to prevent fluctuations. However, this is not shown in FIG. 1 in detail for sake of clarity.

A second partial energy storage device 9 is connected in series toward the high-voltage network 3 with the first partial energy storage device 6, which is connected in parallel with the first energy storage device 4. The second partial energy storage device 9 is in this embodiment constructed as a supercapacitor, supplying the rest of the required voltage, in this case 36 V. The first partial energy storage device 6 and the second partial energy storage device 9 represent the second energy storage device 5, which provides the second voltage for the high-voltage network 3.

The high-voltage network 3 has high-voltage loads 10, for example an electric turbocharger, however in this embodiment more particularly a front windshield heater for a front windshield of the motor vehicle.

Moreover, the high-voltage network 3 and the low-voltage network 2 are connected with each other via a DC-DC converter 11, which can be, as indicated by the arrow 12, operated in both directions. Depending on the control of the DC-DC converter 11, the second partial energy storage device 9 can thus be charged with a certain charge power via the generator; alternatively, energy of the second partial energy storage device 9 can also be used in the low-voltage network 2.

It should also be noted, which is not shown in more detail for sake of clarity, power may be supplied to at least a portion of the high-voltage loads 10 from the low-voltage network when the second partial energy storage device 9 is discharged, so as to enable a (albeit restricted) operation. A suitable switching device may be provided for this purpose.

The first and the second partial energy storage devices 6, 9 need not necessarily use supercapacitors, like in this embodiment, but other energy storage devices free from hysteresis in the charging voltage and the discharging voltage may be used, in particular combinations of different cells, for example a combination of three lithium-ion cells (LMO) with a lithium-titanate cell (LTO). A combination of supercapacitors with such cells is also feasible. However, a supercapacitor at least as a second partial energy storage device 9 is advantageous especially in relation to high-power loads among the high-voltage loads 10.

For example, high current surges occurring in the high-voltage network 3 have a lower impact on the voltage in the low-voltage network 2 because their internal resistances are also connected in parallel due to the parallel connection of the first energy storage device 4 and the first part of energy storage device 6; the absence of hysteresis in the first partial energy storage device 6 has also a positive effect.

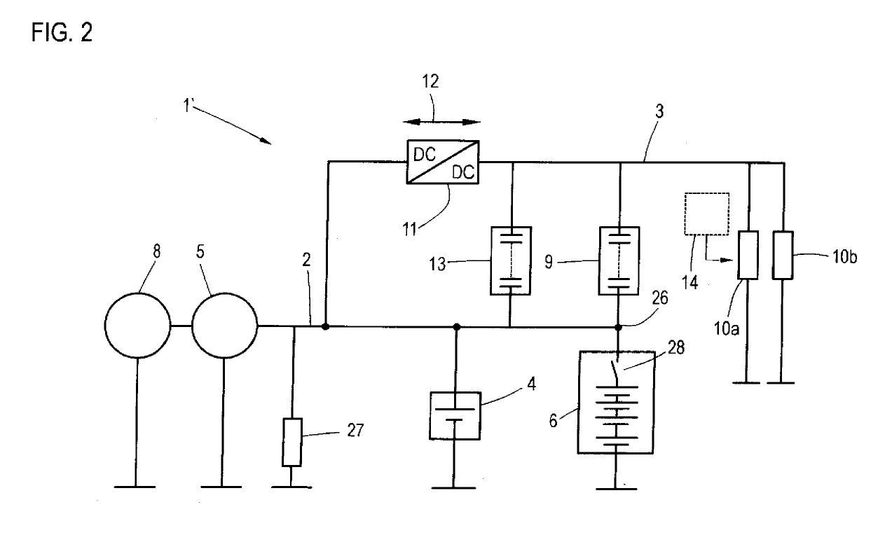

FIG. 2 shows a slightly modified embodiment of an electrical system 1′ compared to FIG. 1, wherein for sake of simplicity like components are denoted by the same reference numerals. As seen, unlike in the first embodiment in FIG. 1, a lithium-ion battery 13 is connected in parallel with the second partial energy storage device 9 which is here also constructed as a supercapacitor. This enables a long-duration energy supply in the high-voltage network 3, so that for purpose of illustration the high-voltage loads 10 are here divided into high energy loads 10a, which do not require a high peak power, but power over a long time, and power loads 10b, which require large pulse-like power. A high energy user 10a may, for example, be a front windshield heater configured to heat a front windshield of the motor vehicle for, for example, 20 to 40 seconds at 1000 W. A high-power load 10b is for example an electric turbocharger, from which, for example, 5 to 7 kW is required for 2 to 3 seconds. By additionally providing the lithium-ion battery 13, an energy storage device for electrical energy allowing long-term operation is obtained, which further improves the overall arrangement. Various applications can be encompassed by the second partial energy storage device 9 constructed as a supercapacitor and the lithium-ion battery 13.

In the present example, the first partial energy storage device 6 has also been changed and now includes three lithium-ion cells and a lithium-titanate cell.

FIG. 2 shows also a switching device 28 on the second partial energy storage device 6. The switching device 28 may advantageously also be installed in the supply line to center tap 26 so as to allow the first energy storage device 4 to be completely disconnected from the second energy storage device 5.

An increased comfort for users of the motor vehicle can be realized by skillful control of the high-voltage loads 10, 10a, 10b in the onboard electrical systems 1, 1′. For this purpose, FIG. 1 and FIG. 2 show schematically a control device 14 which in this example is associated with the windshield heater, which can already activate the windshield heater in response to a suitable activation signal even before startup of the motor vehicle, in particular even before the driver has entered the vehicle. For this purpose, the activation signal may represent, for example, operating a control element on a key for the vehicle or another type of remote control, wherein however automatic detection methods for such an activation signal are also feasible. This ultimately enables the installation of the second partial energy storage device 9, or of the second partial energy storage device 9 and the lithium ion battery 13, which takes over a substantial part of the load from the first power storage device 4 and the low-voltage network 2, thereby retaining the fundamental starting capability via the starter 8.

This results from the fact that the second partial energy storage device 9 (and in the example of FIG. 2, the lithium-ion battery 13) are already charged so that their energy can be used here. A period of low load in the onboard electrical system 1, 1′ can advantageously be used to recharge the partial energy storage device 9 and optionally the lithium-ion battery 13.

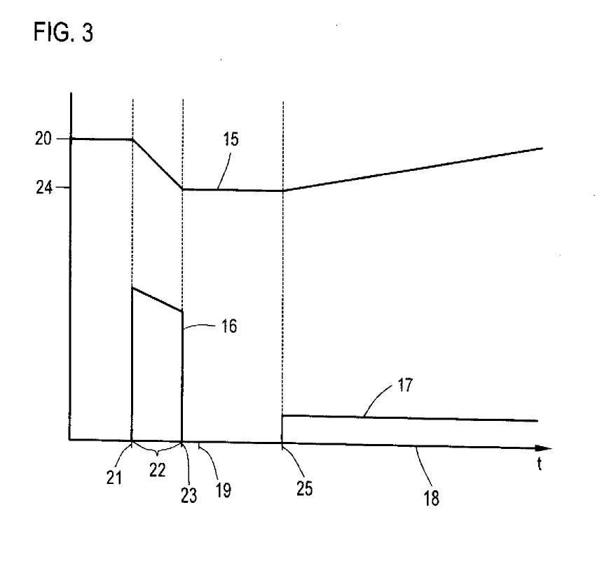

This control concept implemented by the control device 14 is further illustrated by the curves in FIG. 3. FIG. 3 shows three variables as a function of time, namely first as curve 15 the energy available for the high-voltage network 3, as curve 16 the current through the resistance of the heated front windshield, and as curve 17 the charging current via the DC-DC converter 11 for recharging the second partial energy storage device 9 and optionally the lithium ion battery 13. The axis 18 indicates the time.

The engine of the motor vehicle is started in this embodiment at a time 19. This point in time is shown in the example as following the time period 22; it can also fall within the time period 22.

Initially, the second partial energy storage device 9 and optionally the lithium ion battery 13 are in a certain state of charge 20. At a time 21, which may occur even before the driver enters the motor vehicle, the control device 14 receives the activation signal, for example after actuating an operating element on the key of the motor vehicle by the approaching driver. The control device 14 then activates the front windshield heater at the time 21, producing in a time segment 22, which may last, for example, four to six minutes, a current flow which heats a heating resistor in the windshield. When the windshield is defrosted, at time 23, the existing charge is reduced to a lower state of charge 24, but in relation to the energy storage device of the low-voltage network 2, to which only a small load is applied and not to such an extent that starting of the motor vehicle becomes impossible. The engine of the motor vehicle is then started at time 19, meaning that the generator 7 is also active. Nevertheless, the second partial energy storage device 9 and optionally the lithium ion battery 13 are not immediately charged because there is initially still a heavy load on the onboard electrical system 1, 1′. The charge is supplied via the DC-DC converter 11 only when the load of the onboard electrical system 1, 1′, in particular of the low-voltage network 2, has decreased below a threshold value, at time 25. However, the power is obviously lower than when realizing the comfort function with the front windshield heater. The charging process can therefore take, for example, 20 to 30 minutes.

It should finally be noted that the control process, as explained with reference to FIG. 3, can also be used away from the motor vehicle equipped the inventively designed electrical system 1, 1′, for example, when a second energy storage device for the high-voltage loads is connected separately to ground.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A motor vehicle comprising an onboard electrical system, the onboard electrical system having a low-voltage network operating at a first voltage and having a first electrical energy storage device, and a high-voltage network operating at a second voltage higher than the first voltage and having a second electrical energy storage device,
wherein the second energy storage device is divided in a first partial energy storage device that has a voltage corresponding to the voltage of the first energy storage device and is connected in parallel with the first energy storage device, and a second partial energy storage device that is connected in series with the first partial energy storage device.

2. The motor vehicle of claim 1,
wherein at least one of the first partial energy storage device and the second partial energy storage device is an energy storage device lacking hysteresis in a charging and discharging voltage.

3. The motor vehicle of claim 1,
wherein the first energy storage device is a lead battery.

4. The motor vehicle of claim 1,
wherein at least one of the first partial energy storage device and the second partial energy storage device is a supercapacitor.

5. The motor vehicle of claim 1, further comprising a lithium-ion battery having a voltage corresponding to the voltage of the second partial energy storage device and being connected in parallel with the second partial energy storage device.

6. The motor vehicle of claim 1, further comprising a load connected to the high-voltage network, wherein the connected load provides a comfort function or comprises an electric turbocharger.

7. The motor vehicle of claim 6, wherein the connected load comprises a heating device.

8. The motor vehicle of claim 7, wherein heating device is configured to heat a front windshield of the motor vehicle.

9. The motor vehicle of claim 6, further comprising a control device configured to activate the load realizing the comfort function before startup of the motor vehicle in response to an activation signal.

10. The motor vehicle of claim 9, wherein the load realizing the comfort function is activated before a driver enters the motor vehicle.

11. The motor vehicle of claim 9, wherein the activation signal is transmitted from a key associated with the vehicle or based measurement data describing a location the key.

12. The motor vehicle of claim 9, wherein the control device is configured to charge the second partial energy storage device when utilization of the onboard electrical system of the motor vehicle is below a threshold value.

13. The motor vehicle of claim 1, further comprising a DC-DC converter connecting the high-voltage network and the low-voltage network.

14. The motor vehicle of claim 13, further comprising a generator configured to charge the first energy storage device and the second energy storage device.

15. The motor vehicle of claim 13, wherein energy from the second partial energy storage device is supplied to the low-voltage network via the DC-DC converter.

16. The motor vehicle of claim 1, wherein the first voltage is 12 V.

17. The motor vehicle of claim 1, wherein the second voltage is in a range from 36 to 52 V.

18. The motor vehicle of claim 1, wherein the second voltage is 48V.

19. A method of operating in a motor vehicle a load realizing a comfort function, wherein the motor vehicle has an onboard electrical system comprising a low-voltage network operating at a first voltage and having a first electrical energy storage device, and a high-voltage network operating at a second voltage higher than the first voltage and having a second electrical energy storage device, the method comprising:
connecting the load to the high-voltage network, and
activating the load before startup of the motor vehicle.

20. The method of claim 19, wherein the load is activated before a driver enters the motor vehicle.
